(19) United States
(12) Patent Application Publication
(10) Pub. No.: US 2004/0008513 A1
(43) Pub. Date: Jan. 15, 2004

(54) Connecting structure of a bulb assembly

(76) Inventors: Kuo-Fen Shu, Hsinchu (TW); Sen-Hung Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/190,681

(22) Filed: Jul. 9, 2002

(51) Int. Cl. F21V 21/08

(52) U.S. Cl. 362/249; 362/396; 362/806

(57) ABSTRACT

The present invention relates to a connecting structure of a bulb assembly, which includes a holder with a bulb and a shell to connect with the holder. The holder is provided with a T-shape hook, which is capable of being folded. The shell is provided with an engaged base, which includes two opposite slices while a gap will be formed under each slice. When the holder is received in the shell, the T-shape hook can be engaged between two slices that makes the holder (1) connect with engaged base firmly.

### BACKGROUND OF THE INVENTION

A conventional bulb assembly includes a holder to connect with a bulb and a shell. The holder with the bulb is received in the shell. This connection between the holder and the shell is not tight. The holder with the bulb is often loose relating to the shell that causes bad conductive connection of electric contact. There are some improvements but still out of work.

The primary object of the invention is to provide a connecting structure of a bulb assembly, which includes a holder having a T-shape hook and a shell having an engaged base that provides a better connecting effect therebetween. Now the features and advantages of the present invention will be described in detail with reference to the accompanying drawings.

### BRIEF DESCRIPTION OF ACCOMPANYING DRAWINGS

FIG. 1 is an exploded perspective view showing a connecting structure of a bulb assembly according to the present invention.

FIG. 2 is an assembled perspective view of FIG. 1.

FIGS. 3-5 are plan views showing the connecting procedures between the holder and the shell.

FIGS. 6-8 are top plan views of FIGS. 3-5.

### DETAILED DESCRIPTION OF PREFERRED EMBODIMENTS

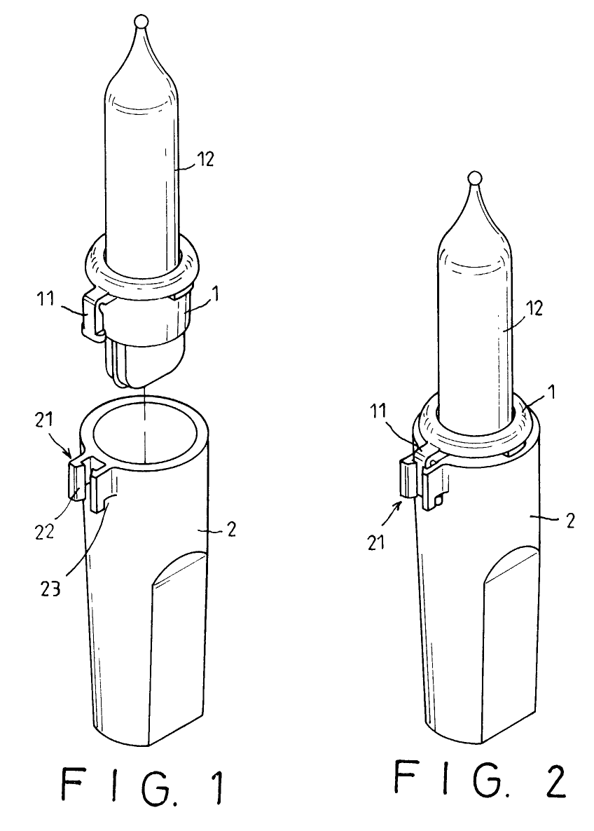

Please refer to FIGS. 1 and 2, the present invention includes a holder (1) with a bulb (12) and a shell (2). The characteristic is that the holder (1) is provided with a T-shape hook (11), which is capable of being folded. The shell (2) is provided with an engaged base (21), which includes two opposite slices (22) while a gap (23) will be formed under each slice (22). When the holder (1) is received in the shell (2), the T-shape hook (11) can be engaged between two slices (22) that makes the holder (I) connect with engaged base firmly.

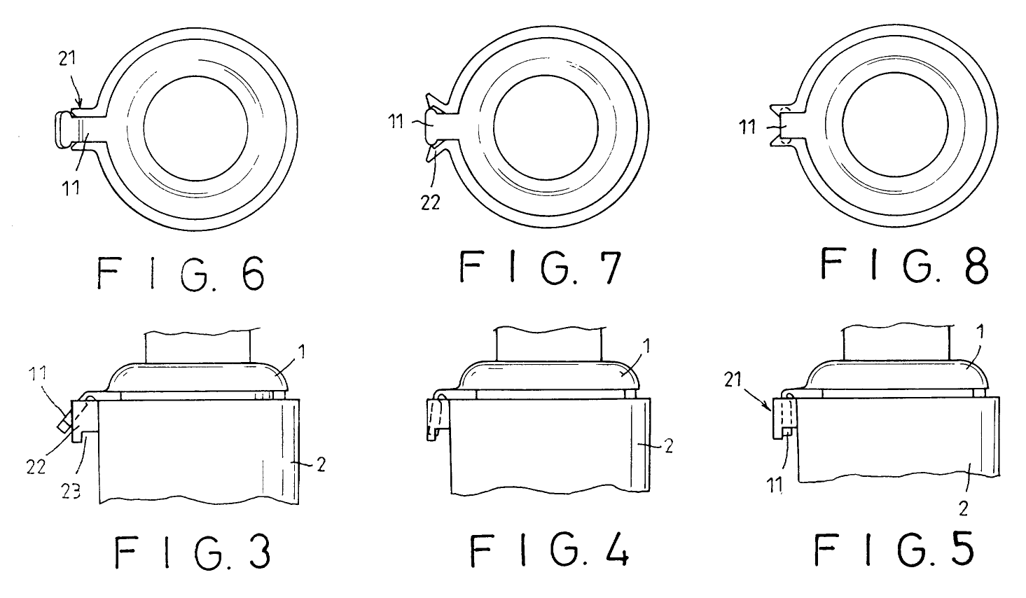

Referring to FIGS. 3 to 8, due to the slice (22) is made of elastic material, it will be elastic moved outward (as FIGS. 4, 7) as the T-shape hook (11) is pushed between them. After this engagement, the slice (22) is recovery while the head of the T-shape hook ( 11) is received in the gap (23), as shown in FIGS. 5, 8. A secure connection is then obtained.

What is claimed is:

1. A connecting structure of a bulb assembly including a holder connecting with a bulb and then received in a shell, and the characteristic is the holder being provided with a T-shape hook, which is capable of being folded and the shell (2) being provided with an engaged base, which includes two opposite slices while a gap is formed under each slice; the holder being received in the shell, and the T-shape hook being engaged between two slices to force the holder being connected with engaged base firmly.
